(19) United States
(12) Patent Application Publication
(10) Pub. No.: US 2006/0055964 A1
(43) Pub. Date: Mar. 16, 2006

(54) Relaying apparatus

(75) Inventor: Hiroshi Tsuchitani, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/222,860

(22) Filed: Sep. 12, 2005

(30) Foreign Application Priority Data
Sep. 10, 2004 (JP) 2004-263864

(51) Int. Cl. G06F 3/12

(52) U.S. Cl. 358/1.15

(57) ABSTRACT

A relaying apparatus of the present invention is interposed between a device and a printer and controls the operation of the device by checking the status of the printer. The relaying apparatus has a microcomputer that causes an IrDA unit to negotiate with a printer. The printer has a microcomputer that associates a setting state of a print data correction switch with an equipment name and gives the equipment name to the relaying apparatus when a negotiation begins. The microcomputer of the relaying apparatus performs image processing based on the equipment name obtained from the printer and does not request the device to send new image data while the printer is operating according to the setting state of the print data correction switch.

### BACKGROUND OF THE INVENTION

1. Field of the Invention

The present invention relates to a relaying apparatus having: a first communication section which communicates with a device having image data; and a second communication section which communicates using infrared with a printer receiving image data via infrared communication and performing printing. The relaying apparatus receives image data from the device and sends the image data to the printer.

2. Description of the Related Art

There have been proposed many techniques for wirelessly sending image data from a device to a printer via a wireless communication unit thereby allowing a printer to print an image (see Japanese patent application publications No. 2001-253123 and No. 10-255190 for example). If a printer is allowed to perform printing via wireless communication, an easy-to-handle printer can be realized because no cable is required.

There are various kinds of devices such as personal computers, digital cameras, video cameras, etc., which can send image data to a printer. In addition, it is expected that various kinds of portable devices capable of using image data will be proposed. All these devices maybe each equipped with a wireless communication unit. However, it is very convenient if a relaying apparatus capable of being attached to any of these devices is produced from which image data is sent to a printer.

When creating such a relaying apparatus, it is necessary to incorporate therein the function of controlling timing of sending image data received from a device by monitoring the operating status of a printer. Otherwise, the relaying apparatus may relay image data from the device to the printer before the printer finishes the processing, which may cause a failure of the printer.

### SUMMARY OF THE INVENTION

The present invention has been made in view of the above circumstances and provides a relaying apparatus that is interposed between a device and a printer and is capable of controlling the timing of sending image data to be sent from the device by monitoring the operating status of the printer.

A relaying apparatus according to the present invention includes: a first communication section which communicates with a device sending image data; and a second communication section which communicates using infrared radiation with a printer receiving image data via infrared communication, the relaying apparatus receiving image data from the device and sending the image data to the printer, wherein:

the relaying apparatus is adapted to connect to a printer that is capable of setting a desired image processing mode of the printer,

the relaying apparatus further comprises a printer recognition section which recognizes a setting state of the image processing mode of the printer by infrared communication with the printer, and

the relaying apparatus changes an image transmission method according to the setting state of the image processing mode of the printer recognized by the printer recognition section.

In the relaying apparatus of the present invention, the printer recognition section recognizes a setting state of the image processing mode of the printer via infrared communication by the second communication section. The relaying apparatus then changes an image transmission method according to the recognized setting state of the image processing mode recognized by the printer recognition section.

As an example of the change of the image transmission method, it is conceivable that the time between sending the current image data to the printer and sending the next image data to the printer may be changed according the setting state of the image processing mode. When pieces of image data are sequentially sent from the relaying apparatus to the printer, the printer might receive the current image data while processing the previous image data, which causes a failure of the printer. The change of the image data sending time prevents such a failure from occurring.

Accordingly, there is realized a relaying apparatus that controls data sending timing based on the setting state of the image processing mode of the printer recognized by the printer recognition section.

Further, in the relaying apparatus according to the present invention, preferably, the relaying apparatus is also capable of setting a desired image processing mode of the relaying apparatus,

the relaying apparatus further includes an image processing section which performs image processing according to the image processing mode set in the relaying apparatus, and

the second communication section sends the setting state of the image processing mode of the relaying apparatus and the image data.

When the relaying apparatus is also capable of setting a desired image processing mode, it leads to the situation in which the setting state of the image processing mode of the relaying apparatus and that of the printer are both in the ON state.

Thus, in this relay apparatus of the present invention, the image transmission method of sending image data is changed to the image transmission method of sending both image data and the setting state of an image processing mode to the printer. This enables the printer to subject the image data to image processing reflecting the setting state of the image processing mode of the relaying apparatus upon receipt of both the setting state and the image data.

This arrangement prevents a double processing by the relaying apparatus and the printer.

Furthermore, in the relaying apparatus according to the present invention, preferably, the printer recognition section recognizes, through communication with the printer, a setting state of the image processing mode of the printer and recognizes the type of the printer,

the image processing section subjects the image data received from the device to image processing according to the type of the printer recognized by the printer recognition section.

If the image processing section subjects the image data received from the device to image processing according to the type of the printer recognized by the printer recognition section, the relaying apparatus can send image data to the printer after subjecting the image data to image processing suitable for a “peculiarity” such as the color property of the printer. This enables the printer to receive such image data and print a high quality image, in which a “peculiarity” of the printer has been corrected, based on the received image data.

As described above, the present invention realizes a relaying apparatus that is interposed between a device and a printer and is capable of controlling the timing of sending image data to be sent from the device by monitoring the operating status of the printer.

### BRIEF DESCRIPTION OF THE DRAWINGS

FIG. 1 is a diagram showing a relaying apparatus according to a first embodiment of the present invention;

FIG. 2 is a diagram showing the internal structure of the relaying apparatus shown in FIG. 1;

FIG. 3 is a diagram showing the contents of controls performed by a microcomputer of the relaying apparatus and a microcomputer of a printer shown in FIG. 1 before and after a negotiation;

FIG. 4 is a diagram showing a relaying apparatus according to a second embodiment of the present invention;

FIG. 5 is a diagram showing the internal structure of the relaying apparatus shown in FIG. 4; and

FIG. 6 is a diagram showing the contents of controls performed by a microcomputer of the relaying apparatus and a microcomputer of a printer shown in FIG. 4 before and after a negotiation.

### DETAILED DESCRIPTION OF THE INVENTION

Embodiments of the present invention will be described below.

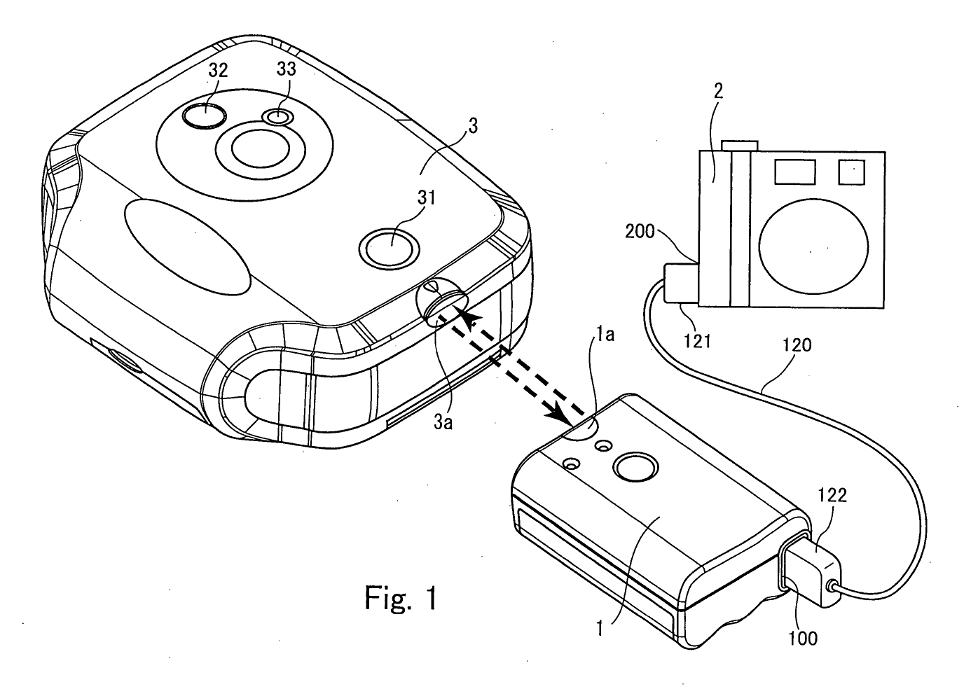

FIG. 1 is a diagram showing a relaying apparatus according to a first embodiment of the present invention.

FIG. 1 illustrates a state in which a relaying apparatus 1 according to the present invention is interposed between a printer 3 and a digital camera 2 that is an example of the device.

As shown in FIG. 1, connectors 121 and 122 of a USB cable 120 are connected to a USB connector port 200 of the digital camera 2 and a USB connector port 100 of the relaying apparatus 1, respectively. Further, a light sending/receiving unit la of an Infrared Data Association (IrDA) unit incorporated in the relaying apparatus 1 and a light sending/receiving unit 3a of an IrDA unit incorporated in the printer 3 are arranged to face each other. In the printer 3, a pack containing a set of ten instant film sheets is inserted, and an image based on image data is printed on each of the film sheets and output.

Disposed on the top surface of the printer 3 shown in FIG. 1 is a power switch 31. The printer 3 is activated by turning on the power switch 31. When image data is sent from the digital camera 2 to the printer 3 during the active state of the printer 3, an image based on the image data is printed on an instant film sheet and discharged from the printer 3. Also, an image can be reprinted upon operating a reprint switch 32 disposed on the top surface of the printer 3 immediately after an instant film sheet is discharged. In addition, a print data correction switch 33 for setting an image processing mode in the printer 3 is disposed on the top surface of the printer 3, so that a user can adjust light and shade of the image to be printed. When the print data correction switch 33 is operated while the printer 3 is in the active state, an image processing section of the printer 3 performs luminance correction on image data that is received from the digital camera 2 via the relaying apparatus 1. The image whose luminance has been corrected is then printed on an instant film sheet and the film sheet is discharged from the printer 3. On the other hand, when the print data correction switch 33 is not operated, i.e. when it is in the OFF state, the image processing section performs no correction on image data received from the digital camera 2, an image based on the image data is printed on an instant film sheet, and the film sheet is discharged from the printer 3.

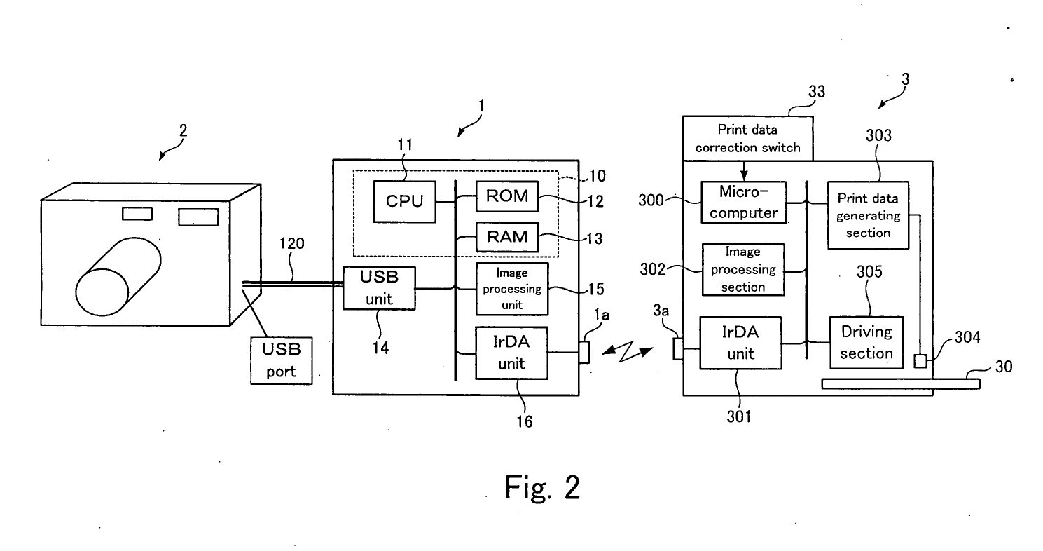

FIG. 2 is a diagram showing the internal structure of the relaying apparatus 1.

FIG. 2 also illustrates the internal structures of the printer 3 besides that of the relaying apparatus 1.

The relaying apparatus 1 shown in FIG. 2 includes a microcomputer 10 composed of a CPU 11, a ROM 12, and a RAM 13. Upon receipt of a print order from the digital camera 2 through a USB unit 14, the microcomputer 10 switches the USB unit 14 to the receiving state, thereby allowing the USB unit 14 to receive image data from the digital camera 2. After allowing the USB unit 14 to receive the image data, the microcomputer 10 supplies an image processing section 15 with the image data stored in a memory of the USB unit 14. The image data is then subjected to image processing by the image processing section 15 according to the type of the printer. The USB unit 14 corresponds to the “first communication section” according to the present invention.

In the present embodiment, the microcomputer 10 of the relaying apparatus 1 commands an IrDA unit 16 to negotiate with an IrDA unit 301 of the printer 3 in order to obtain the type of the printer 3 as well as the setting state of the print data correction switch 33 of the printer 3. This allows the image processing section 15 to carry out image processing according to the type of printer. When a parameter according to the obtained type of the printer 3 is set in the image processing section 15, the image processing section 15 performs image processing according to the type of the printer 3. The IrDA unit 16 corresponds to the “second communication section” according to the present invention.

Upon obtaining the type of the printer 3 and the setting state of the print data correction switch 33 through the negotiation with the printer 3 by using the IrDA unit 16, the microcomputer 10 calculates the time required to output a print by the printer 3 according to the setting state of the print data correction switch 33 and causes the USB unit 14 to wait without operating during the calculated time. Alternatively, the microcomputer 10 sets a parameter in the image processing section 15 for enabling the image processing section 15 to carry out image processing according to the type of the printer 3 (e.g. processing suitable for a “peculiarity” such as the color property of an image processing section in a printer). When the parameter according to the type of the printer 3 is set in the image processing section 15 in this way, image data is subjected to image processing and sent to the printer 3 from the light sending/receiving unit 1a of the IrDA unit 16 via infrared communication. Upon receipt of the image data, the printer 3 prints an image on an instant film sheet based on the received image data and the sheet is discharged. Until this instant film sheet is completely discharged from the printer 3, processing for the next image data cannot be performed. Therefore, until then, the relaying apparatus 1 does not request the digital camera 2 through the USB unit 14 to send the next image signal.

When the image data is received via infrared communication by the IrDA unit 301 including the light sending/receiving unit 3a of the printer 3, the received image data is supplied to an image processing section 302. The image data is then subjected to image processing by the image processing section 302 according to the setting state of the print data correction switch 33 and supplied to a print data generating section 303. The print data generating section 303 then generates print data and an exposure head 304 is driven to form a latent image on an instant film sheet 30 based on the generated print data. The instant film sheet 30 having the latent image formed thereon is driven by a driving (developing) section 305 and discharged from the printer 3. The instant film sheet 30 used by the printer 3 contains a self-developer that spreads over the entire film sheet while it is discharged from the printer 3.

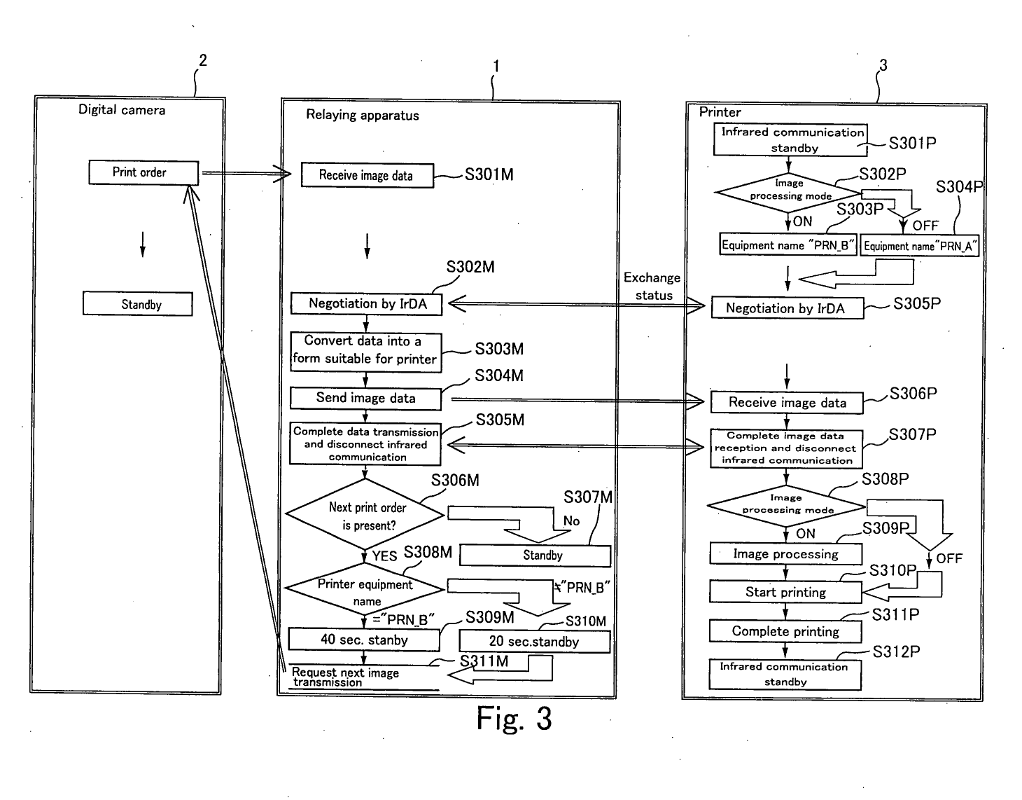

Now, with reference to FIG. 3, there will be described how controls are performed by the microcomputer 10 and a microcomputer 300 shown in FIG. 2 before and after the relaying apparatus 1 negotiates with the printer 3 through the IrDA 16 in response to a print order from the digital camera 2.

FIG. 3 is a diagram showing the contents of the controls performed by the microcomputer 10 of the relaying apparatus 1 and the microcomputer 300 of the printer 3 before and after a negotiation.

FIG. 3 illustrates processing performed by the microcomputer 10 of the relaying apparatus 1 and the microcomputer 300 of the printer 3 in a mixed manner. Accordingly, M is attached to each processing step performed by the microcomputer 10 whereas P is attached to each processing step performed by the microcomputer 300 in the following description. Steps with M are included in the processing carried out by the microcomputer 10 of the relaying apparatus 1 whereas steps with P are included in the processing carried out by the microcomputer 300 of the printer 3.

A sequence of processing steps shown in FIG. 3 starts when a print order is sent from the digital camera 2 to the relaying apparatus 1 through the USB cable 120.

First, when a print order is sent from the digital camera 2 to the relaying apparatus 1 through the USB cable 120, the microcomputer 10 of the relaying apparatus 1 receives the print order by the USB unit 14 and commands the USB unit 14 to receive image data at step S301M.

After causing the USB unit 14 to receive the image data sent from the digital camera 2, the microcomputer 10 commands the IrDA unit 16 to negotiate with the IrDA unit 301 of the printer 3 at step S302M. The steps up to here are performed by the microcomputer 10 of the relaying apparatus 1 in response to a print order sent from the digital camera 2.

At step S302M, the negotiation with the printer 3 is carried out. Therefore, steps performed by the microcomputer 300 of the printer 3 before the negotiation begins will be described below.

First, the microcomputer 300 brings the IrDA unit 301 to a standby state at step S301P so that it can receive image data from the relaying apparatus anytime.

Next, at step S302P, the microcomputer 300 determines whether the image processing mode is in the ON state or the OFF state by detecting the setting state of the print data correction switch 33 of the printer 3. If it is determined that the print data correction switch 33 is operated and the image processing mode is in the ON state at step S302P, the flow goes to step S303P where an equipment name “PRN_B” is given as a parameter indicating the ON state. On the contrary, if it is determined that the image processing mode is in the OFF state at step S302P, the flow goes to step S304P where an equipment name “PRN_A” is given as a parameter indicating the OFF state. When the step for supplying an equipment name according to the setting state of the print data correction switch 33 of the printer 3 is completed by the microcomputer 300 in this way, the flow goes to the next step S305P where the microcomputer 300 commands the IrDA unit 301 to carry out a negotiation.

This sequence of steps by the microcomputer 300 enables the relaying apparatus 1 to obtain the setting state of the print data correction switch 33 of the printer 3 through a negotiation in the form of an equipment name. For example, if the relaying apparatus 1 obtains the equipment name “PRN_B”, the microcomputer 10 of the relaying apparatus 1 can recognize the type of the printer 3 as well as the setting state of the print data correction switch 33 of the printer 3.

Next, the flow goes to step S303M where the image data is converted into a form suitable for the type of the printer 3 based on the equipment name “PRN_B”. Subsequently, at step S304M, the converted image data is sent to the printer 3.

In response, the microcomputer 300 of the printer 3 causes the IrDA unit 301 to receive the image data at step S306P and transfers the received image data to the image processing section 302. Subsequently, at step S307P, upon detecting the completion of the image data reception, the microcomputer 300 provides the relaying apparatus 1 with a notice of the completion of the image data reception (e.g. EOF) and turns off the power of the IrDA unit 301. The power of the IrDA unit 16 in the relaying apparatus 1 is also tuned off at step S305M. Accordingly, the relaying apparatus 1 and the printer 3 are disconnected from each other and each of the microcomputers 10 and 300 independently controls the respective internal components.

Now, the contents of the control performed by the microcomputer 300 will be described first.

At step S308P, the microcomputer 300 determines whether the image processing mode is in the ON state or OFF state. If it is determined that the image processing mode is in the OFF state, the flow goes to step S310P where printing is started. Subsequently, upon detecting the completion of the printing at step S311P, the microcomputer 300 brings the IrDA unit 301 to a standby state at step S312P and the flow ends.

Alternatively, if it is determined that the image processing mode is in the ON state at step S308P, the flow goes to step S309P where the image data is subjected to image processing (luminance correction) to increase the luminance level (Y) of the entire image and goes to step S310P where printing is started. Subsequently, upon detecting the completion of the printing at step S311P, the microcomputer 300 brings the IrDA unit 301 to a standby state at step S312P and the flow ends.

On the other hand, in the relaying apparatus 1, after turning off the power of the IrDA unit 16 at step S305M, the microcomputer 10 determines whether or not the next print order has been sent from the digital camera 2, for example by referring to the contents of a register in the USB unit 14. If it is determined that the next order has not been sent, the flow goes to step S307M where the microcomputer 10 brings the USB unit 14 to a standby state.

If it is determined that the next order has been sent at step S306M, the flow proceeds to Yes and whether the equipment name of the printer 3 is “PRN_B” or “PRN_A” is determined at step S308M. If it is determined that the equipment name is “PRN_B” at step S308M, the flow goes to step S309M where a 40 seconds standby process is performed. Subsequently, the flow goes to step S311M where the microcomputer 10 sends a next image transmission request to the digital camera 2 through the USB unit 14 and the flow ends.

If it is determined that the equipment name is other than “PRN_B” at step S308M, the flow goes to step S310M where a 20 seconds standby process is performed. Subsequently, the flow goes to step S311M where the microcomputer 10 sends a next image transmission request to the digital camera 2 through the USB unit 14 and the flow ends.

Whether the equipment name is “other than PRN_B” or not is determined at step S308M because, if a printer of completely different type is set, an equipment name other than “PRN_B” may be given and obtained by the relaying apparatus 1.

By allowing the relaying apparatus 1 and the printer 3 to negotiate with each other in this way, the microcomputer 10 of the relaying apparatus 1 can keep track of the status of the printer 3. Accordingly, when a print order is sent from the digital camera 2, if the printer 3 is still in process of print output, the microcomputer 10 can maintain the USB unit 14 in a standby state without sending a transmission request to the digital camera 2 through the USB unit 14.

As described above, according to the present invention, it is possible to realize a relaying apparatus that is interposed between a device and a printer and capable of controlling the timing of sending image data to be sent from a device by keeping track of the status of the printer.

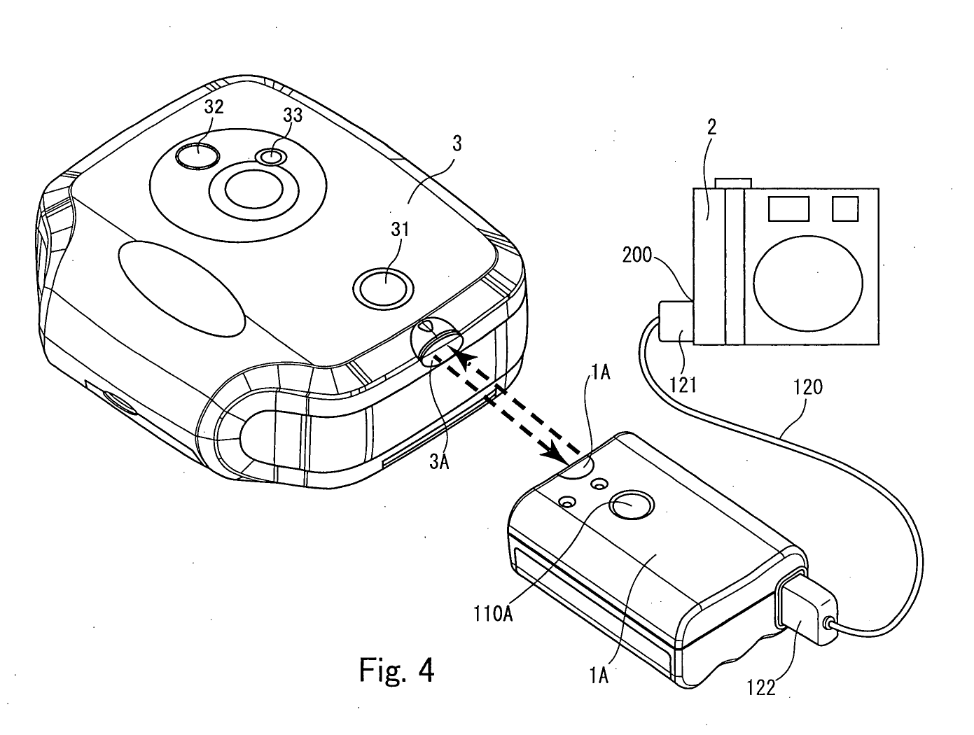

FIG. 4 is a diagram showing a relaying apparatus according to a second embodiment of the present invention.

FIG. 4 is the same as FIG. 1 except that a relaying apparatus 1A shown in FIG. 4 includes a data correction switch 110A similar to a print data correction switch 33 of a printer 3.

Because the print data correction switch 110A is the same as the print data correction switch 33, if image data is transmitted to the printer 3 through the relaying apparatus 1A in response to a print order from a printer 2 while both switches remain turned on, there is a risk that a double shading process will be applied to the image data, i.e. a shading process by the relaying apparatus 1A and subsequently a shading process by the printer 3.

For this reason, an improvement is made in the present embodiment in such a manner that the setting state of either the print data correction switch of the relaying apparatus 1A or that of the printer 3 is adopted through the negotiation described above.

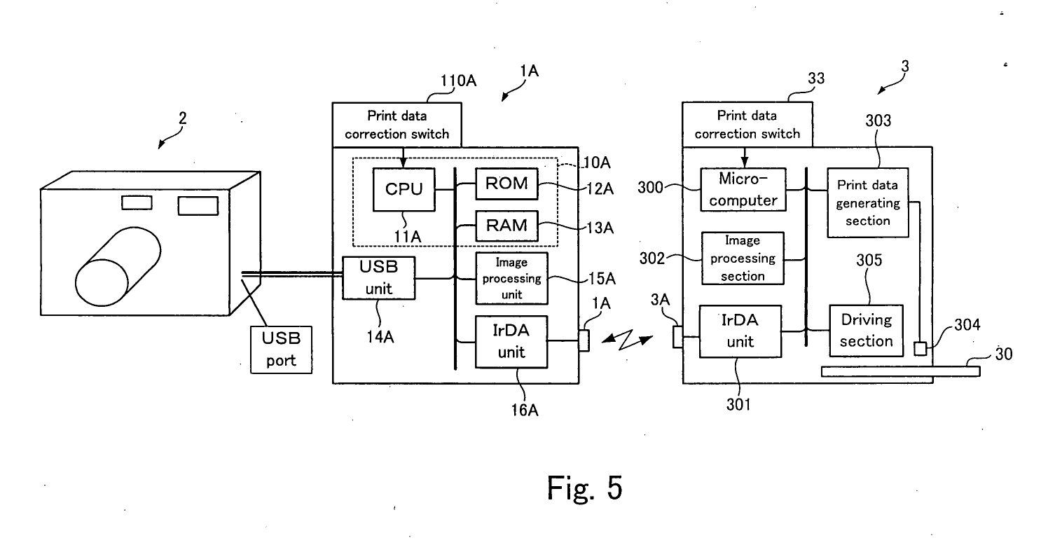

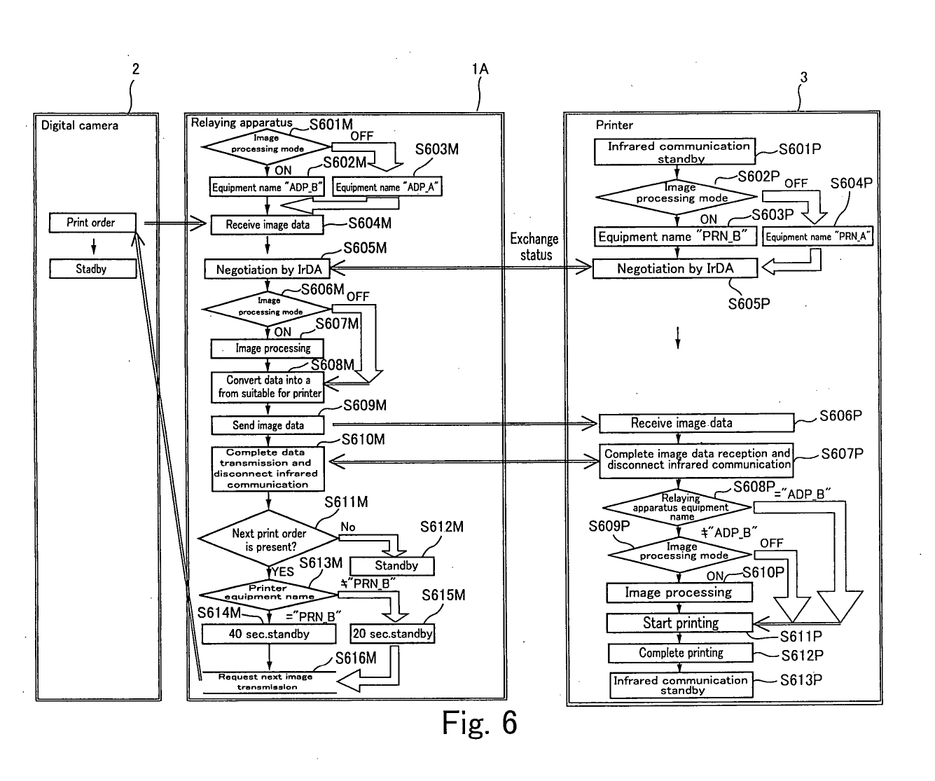

FIG. 5 is a diagram showing the internal structure of the relaying apparatus 1A shown in FIG. 4. FIG. 6 is a diagram showing the contents of the controls performed by a microcomputer 10 of the relaying apparatus 1A and a microcomputer 300 of the printer 3 before and after a negotiation.

The relaying apparatus 1A is the same as the relaying apparatus 1 shown in FIG. 3 except that it includes the print data correction switch 110A. In addition, since the print data correction switch 110A is provided in the relaying apparatus 1A, equipment names are also used in the relaying apparatus 1A, which are similar to “PRN_B” for the ON state and “PRB_A” for the OFF state of the print data correction switch 33 of the printer shown in FIG. 3. Specifically, as shown in FIG. 6, the printer 1 can be notified of the setting state of the relaying apparatus 1A by receiving an equipment name “ADP_B” for the ON state or an equipment name “ADP_A” for the OFF state of the print data correction switch 110A of the relaying apparatus 1A. Except for this additional feature, processing performed by the relaying apparatus 1A is the same as that shown in FIG. 3.

First, at step S601M, the microcomputer 10 determines whether the image processing mode is in the ON state or the OFF state by detecting the setting state of the print data correction switch 110A of the relaying apparatus 1A. If it is determined that the print data correction switch 110A is operated and the image processing mode is in the ON state at step S601M, the flow goes to step S602M where the equipment name “ADP_B” is given as a parameter indicating the ON state. On the contrary, if it is determined that the image processing mode is in the OFF state at step S601M, the flow goes to step S603M where an equipment name “ADP_A” is given as a parameter indicating the OFF state. When the step for supplying a device according to the setting state of the print data correction switch 110A is completed by the microcomputer 10, the flow goes to step S604M where the microcomputer 10 commands the USB unit 14 to receive image data. Upon completion of the receipt of the image data, the microcomputer 10 commands the IrDA unit 16A to negotiate with the IrDA unit 301 of the printer 3. As for the printer 3, steps S601P to S604P performed by the printer 3 before the negotiation are the same as steps S301P to S304P shown in FIG. 3.

At both steps S605M and S605P, the negotiation is carried out and the setting states of both sides are obtained, i.e. either of “PRN_B” or “PRN_A” is obtained by the relaying apparatus 1A and either of “ADP_B” or “ADP_A” is obtained by the printer 3. After that, the negotiation ends.

Processing steps performed after the negotiation by the microcomputer 10A of the relaying apparatus 1A are the same as those shown in FIG. 3 except that steps S606M and S607M similar to steps S308P and S309P shown in FIG. 3 are performed. In addition, steps S608M to S616M are the same as steps S303M to S311M shown in FIG. 3. In contrast, processing steps performed by the printer 3 after the negotiation are slightly different from FIG. 3 because the printer 3 receives “ADP_A” or “ADP_B” as the setting state of the print data correction switch 110A from the relaying apparatus 1A. Steps S606P and 607P are the same as steps S306P and S307P shown in FIG. 3.

At step S608P, it is determined whether the equipment name is “=ADP_B” or “≠ADP_B” based on the obtained equipment name representing the ON state or the OFF state of the setting state of the print data correction switch 110A of the relaying apparatus 1A. At this step, if it is determined that the print data correction switch 110A is in the ON state and the equipment name “ADP_B” is obtained, the flow goes to step S611P to start printing.

On the other hand, if it is determined at step S608P that the print data correction switch 110A is in the OFF state and the equipment name “ADP_A” is obtained, the flow goes to the next step S609P where it is determined whether the image processing mode is in the OFF state or the ON state based on the setting state of the print data correction switch 33 of the printer 3. At this step, if it is determined that the print data correction switch 33 is not operated and in the OFF state, the flow goes to step S611P to start printing. Subsequently, the flow goes to S612P where the printing is completed and further to step S613P where the IrDA unit 301 is shifted to a standby state, and finally the flow ends. On the contrary, if it is determined at step S609P that the print data correction switch 33 is operated and in the ON state, the flow goes to step S610P where image processing is performed and further goes to step S611P to start printing.

With the above arrangement, the printer 3 performs printing without executing image processing when the print data correction switch 110A of the relaying apparatus 1A is operated and in the ON state, whereas the printer 3 performs printing depending on the setting state of the print data correction switch 33 of the printer 3 when the print data correction switch 110A of the relaying apparatus 1A is not operated and in the OFF state. As a result, even when the print data correction switches of the relaying apparatus and the printer are both in the ON state, a double processing by the relaying apparatus and the printer can be prevented.

What is claimed is:

1. A relaying apparatus comprising: a first communication section which communicates with a device sending image data; and a second communication section which communicates using infrared with a printer receiving image data via infrared communication, the relaying apparatus receiving image data from the device and sending the image data to the printer, wherein:
the relaying apparatus is adapted to connect to a printer that is capable of setting a desired image processing mode of the printer,
the relaying apparatus further comprises a printer recognition section which recognizes a setting state of the image processing mode of the printer by infrared communication with the printer, and
the relaying apparatus changes an image transmission method according to the setting state of the image processing mode of the printer recognized by the printer recognition section.

2. The relaying apparatus according to claim 1, wherein the relaying apparatus is also capable of setting a desired image processing mode of the relaying apparatus,
the relaying apparatus further comprises an image processing section which performs image processing according to the image processing mode set in the relaying apparatus, and
the second communication section sends the setting state of the image processing mode of the relaying apparatus and the image data.

3. The relaying apparatus according to claim 1, wherein the printer recognition section recognizes, through communication with the printer, a setting state of the image processing mode of the printer and recognizes the type of the printer,
the image processing section subjects the image data received from the device to image processing according to the type of the printer recognized by the printer recognition section.

4. The relaying apparatus according to claim 2, wherein the printer recognition section recognizes, through communication with the printer, a setting state of the image processing mode of the printer and recognizes the type of the printer,
the image processing section subjects the image data received from the device to image processing according to the type of the printer recognized by the printer recognition section.
